(19) United States
(12) Patent Application Publication
(10) Pub. No.: US 2009/0211186 A1
(43) Pub. Date: Aug. 27, 2009

(54) Double floor type inducing waterproof structure and green roof structure using the same

(75) Inventor: Chae Ho Hong, Gyeonggi-do (KR)

Correspondence Address: HYUN JONG PARK;Park & Associates IP Law LLC, 265 Bic Drive, Suite 106, Milford, CT, 06461, US

(73) Assignees: Gun Yung Construction Co., Ltd., Seoul (KR); Chae Ho Hong, Gyeonggi-do (KR)

(21) Appl. No.: 11/913,932

(22) PCT Filed: Apr. 13, 2007
(86) PCT No.: PCT/KR07/01819

§ 371 Date: Jun. 9, 2008

(30) Foreign Application Priority Data
Apr. 13, 2006 (KR) 10-2006-0033397
May 26, 2006 (KR) 10-2006-0047677
Oct. 19, 2006 (KR) 10-2006-0102056
Dec. 7, 2006 (KR) 10-2006-0123628

(51) Int. Cl. E04D 13/04; A01G 9/02; A01G 25/16

(52) U.S. Cl. 52/302.1; 47/65.9

(57) ABSTRACT

A rooftop double floor-type guidance waterproof structure according to the present invention includes upper panels for preventing water from directly falling onto a rooftop, support members for supporting the upper panels at a uniform height above the rooftop, and drain conduits provided on the tops or sides of the upper panels and configured to guide water, falling onto the upper panels, to a space outside the upper panels, and to drain the water, wherein rooftop tree planting is conducted in a space above the upper panels. As a result, rooftop waterproof performance can be further improved, and rooftop tree planting can be more efficiently realized.

### REFERENCE TO RELATED APPLICATIONS

This is a U.S. national phase application of pending International Patent Application PCT/KR2007/001819 filed on Apr. 13, 2007, which designates the United States and claims priority of Korean Patent Application No. 10-2006-0033397 filed on Apr. 13, 2006; No. 10-2006-0047677 filed on May 26, 2006; No. 10-2006-0102056 filed on Oct. 19, 2006; No 10-2006-0123628 filed on Dec. 7, 2006.

### FIELD OF THE INVENTION

The present invention relates, in general, to a rooftop waterproofing structure and rooftop tree planting structure for buildings, and, more particularly, to a rooftop double floor-type guidance waterproof structure and a rooftop tree planting structure using the structure, in which rooftop waterproofing is realized by installing a double floor structure, using upper panels, on a rooftop, and rooftop tree planting can be also realized on the double floor structure.

### BACKGROUND OF THE INVENTION

Generally, the rooftop of a building is a portion that is directly exposed to the outside. For insulation and waterproofing, an insulating material and a waterproofing material are applied to the rooftop of a building. Furthermore, recently, in order to improve the urban ecosystem and the urban environment, rooftop tree planting has become an important issue.

First, problems with conventional building rooftop waterproofing will be described below.

\textcircled{1} An asphalt waterproofing method, \textcircled{2} a sheet waterproofing method, \textcircled{3} a paint film waterproofing method, and \textcircled{4} a composite waterproofing method are widely used as building rooftop waterproofing methods.

The conventional rooftop waterproofing methods are methods in which a sheet or a paint film material is brought into tight contact with a rooftop. It is very difficult to use the conventional waterproofing methods, which form a new layer on a rooftop and prevent water from penetrating the rooftop, to effectively realize waterproofness due to the cracking characteristics of such rooftop surfaces and limitations of the durability of the waterproof material itself.

That is, the rooftop contact-type waterproofing methods have problems in that the waterproofing effect is considerably reduced due to the aging of a waterproof layer over time, the partial leakage of water occurs due to peeling and removal, because a sheet is removed in the case where waterproofing is performed using the sheet, and the waterproofing effect is considerably reduced due to the cases where rooftop slab concrete undergoes contraction and expansion due to vibration or temperature change, and various types of cracks are created.

Furthermore, although complete waterproofing construction is performed using such a waterproofing method, partial waterproofing construction must be performed again about 3 or 4 years after the first waterproofing construction task, and it is impossible to completely waterproof the portions in which the leakage of water occurs through such repair construction.

Furthermore, in the conventional rooftop contact-type waterproofing methods, protective mortar and protective concrete must be used to protect a waterproof layer, so that problems arise in that the period of construction is long and the cost of construction is high.

Furthermore, the above-described conventional rooftop contact-type waterproofing methods have problems in that the rupture and peeling of a waterproof layer occur due to the cracking of a main structure and a waterproof layer, attributable to double or triple construction, to the connection parts of a waterproof layer, and to a thin paint film. Furthermore, in the case where the leakage of water occurs, it is difficult to detect the location of the leakage of water due to protective mortar or protective concrete, which was applied thereon in order to protect a waterproof layer.

With regard to rooftop tree planting, rooftop tree planting has been continuously encouraged because it has advantages from environmental and economic standpoints, and buildings having sizes equal to or larger than a specific size must be equipped with rooftop tree planting facilities.

Such rooftop tree planting provides advantages related to the restoration of the terrestrial ecosystem, the saving of energy for air conditioning, the mitigation of the urban heat island phenomenon, the prevention of heavy urban floods, the purification of air, the purification of water, the reduction of noise, the improvement of urban scenery, and the improvement of the durability of buildings.

There may be various reasons for the fact that rooftop tree planting is not popular despite the many advantages of such rooftop tree planting given above. The principal reasons therefor may include frequent defects in waterproof layers, high construction cost, and difficulty of maintenance and repair.

The durability of rooftop tree planting is chiefly affected by a waterproof layer and a rootproof layer. Accordingly, the construction of a safe waterproof layer unique to rooftop tree planting, which is not affected by microorganisms or chemical materials because water always exists in the tree plating space, and the management of trees, such as fertilization and tree disease prevention, is performed, and the construction of a rootproof layer, which protects a waterproof layer and the building from the roots of trees with the characteristics of a planting plan taken into account, have becomes important issues.

When a defect occurs in a waterproof layer, there is no method, other than a method of completely removing a soil layer and a vegetation layer and performing waterproofing construction. Even perfect waterproofing construction has a lifetime of 4 to 5 years. Accordingly, a problem occurs at the time that trees are sufficiently grown, the flowers and fruits of the trees mature, and the appearance thereof is beautiful, in that a defect occurs in the lowest waterproof layer, so that the trees must be removed and repair construction must be performed.

Furthermore, when a problem occurs in a rootproof layer, rooftop waterproofing and a floor structure are seriously affected by the phenomena in which the waterproof layer is damaged by the roots of the trees and cracks occur in the rooftop.

Furthermore, in the case where a rooftop tree planting facility is provided, waterproofing material having high waterproofing performance must be applied to a rooftop and a rootproof layer formed of a polyethylene foam sheet and polyethylene vinyl must be formed thereon, so that a problem occurs in that a high cost is incurred for the rooftop tree planting facility.

As a result, when the rooftop tree planting is conducted as described above, or even when rooftop tree planting is not realized, rooftop waterproofing is one of the most important construction elements for buildings. The conventional method of simply installing a waterproof layer in tight contact with a rooftop and blocking the penetration of water into the rooftop has a limitation in the realization of perfect and more efficient waterproofing. In particular, in the case where the rooftop tree planting facility is installed, such a problem becomes more serious.

### SUMMARY OF THE INVENTION

Accordingly, the present invention has been made keeping in mind the above problems occurring in the prior art, and an object of the present invention is to provide a rooftop double floor-type guidance waterproof structure, in which a double floor structure is installed on a rooftop, so that water, falling onto a slab rooftop during rainfall and snowfall, can be naturally guided and drained to a drain hole, rather than forcibly and artificially blocking the water, so that the occurrence of defects in a waterproof layer is fundamentally prevented, thereby realizing more efficient and economical rooftop waterproofing.

A further object of the present invention is to provide a rooftop double floor-type guidance waterproof structure, in which water can be drained through the space between panels, rather than the space under the panels, thereby simplifying the installation process thereof and further increasing rooftop waterproofing performance.

Furthermore, another object of the present invention is to provide a rooftop double floor-type guidance waterproof structure, in which at least one air insulating layer is provided in the lower space of the double floor structure, so that an environment-friendly insulation construction method, which replaces an existing styrene foam method using the inherent features of air, such as high insulation performance and low thermal conductivity, is provided, and the insulation performance of the rooftop can be further improved.

Another object of the present invention is to provide a rooftop double floor-type guidance waterproof structure, in which water sensors are installed in the space under the upper panels, so that the leakage of water through upper panels can be checked, thereby realizing more complete and reliable waterproofing performance.

Still another object of the present invention is to provide a rooftop tree planting structure, in which the above-described objects are achieved and rooftop tree planting is conducted based on a further reinforced water storage structure and an effective drain function realized on the rooftop double floor-type guidance waterproof structure of the present invention, thereby efficiently realizing rooftop tree planting.

In order to accomplish the above objects, the present invention provides a rooftop double floor-type guidance waterproof structure, including upper panels for preventing water from directly falling onto a rooftop; support members for supporting the upper panels at a uniform height above the rooftop; and drain conduits provided on the tops or sides of the upper panels and configured to guide water, falling onto the upper panels, to a space outside the upper panels, and to drain the water.

Preferably, the upper panels comprise a plurality of upper panels, and the drain conduits are provided in the sides of the upper panels or between the upper panels, assembled together.

Preferably, the upper panels comprise a plurality of upper panels, the plurality of upper panels being assembled together by joint members.

Preferably, the drain conduits are formed between the sides of the upper panels and the joint members.

Preferably, the upper panels are combined with insulating plates in lower portions thereof, so that an air pocket can be formed inside the upper panels.

Preferably, the upper panels are provided with drain elements that are located on the upper panels and that are composed of depressed and raised portions to effectively drain water to the drain conduits.

The upper panels may be provided with a plurality of reservoir depressions on the upper surfaces thereof to collect a predetermined amount of water therein.

Preferably, the rooftop double floor-type guidance waterproof structure further includes one or more water sensors that are located under the upper panels and detect leakage of water to the rooftop.

In order to accomplish the above objects, the present invention provides a rooftop tree planting structure, including upper panels for preventing water from directly falling onto a rooftop; support members for supporting the upper panels at a uniform height above the rooftop; and drain conduits provided in the upper panels and configured to guide water, falling onto the upper panels, to a space outside the upper panels and drain the water; wherein rooftop tree planting is conducted in a space above the upper panels.

Preferably, a porous sheet capable of passing water therethrough is laid on upper surfaces of the upper panels, and rooftop tree planting is conducted on the porous sheet.

The present invention has advantages in that the present invention is configured such that the double floor structure is installed on the rooftop and water is naturally guided and drained to the drain hole, rather than using a method of preventing water from penetrating the rooftop, so that the process of installation of waterproofing equipment can be simplified and the cost of construction can be considerably reduced. In particular, the occurrence of detects in a waterproof layer can be fundamentally prevented, so that more efficient and economical rooftop waterproofing can be realized. Furthermore, when the leakage of water occurs, the detection of the location of a defect and the repair of the defect can be rapidly and easily performed.

The present invention has an advantage in that three principal functions that are realized on the uppermost part of a building, that is, ‘waterproofing’, ‘insulation’ and ‘tree planting,’ are integrated into a single triune system, so that more rapid, simple and economical construction is enabled.

Furthermore, the present invention has an advantage in that water can be drained via the space between the panels, rather than the space under the upper panels, so that the process of installation of the double floor structure can be simplified and a rooftop waterproofing function as well as building insulation performance can be further improved.

### BRIEF DESCRIPTION OF THE DRAWINGS

FIG. 1 is a sectional configuration view and a partially enlarged view showing a rooftop waterproofing structure according to the present invention;

FIG. 2 is a cutaway perspective view showing a rooftop waterproofing structure according to the present invention;

FIG. 3 is a partially detailed view of portion “A” of FIG. 2;

FIG. 4 is a perspective view showing the state in which some upper panels and some support plates have been removed from the rooftop waterproofing structure according to the present invention;

FIG. 5 is a detailed view of portion “B” of FIG. 4;

FIG. 6 is a perspective view showing the rooftop waterproofing structure of the present invention with some upper panels removed therefrom;

FIG. 7 is a detailed view of portion “C” of FIG. 6;

FIGS. 8 and 9 are downward and upward perspective views, respectively, showing an intersection joint applied to the present invention;

FIG. 10 is a diagram illustrating a water sensor applied to the present invention;

FIG. 11 is an upward perspective view showing an embodiment in which support plates and support members are installed in a rooftop waterproofing structure according to the present invention;

FIG. 12 is an upward perspective view showing another embodiment in which support plates and support members are installed in a rooftop waterproofing structure according to the present invention;

FIG. 13 is a sectional view showing the construction of a rooftop waterproofing structure according to another embodiment of the present invention;

FIG. 14 is a cutaway perspective view showing the rooftop waterproofing structure according to another embodiment of the present invention;

FIG. 15 is a sectional view showing the state in which rooftop tree planting is conducted on the rooftop waterproofing structure according to the present invention; and

FIG. 16 is a sectional view showing the construction of another embodiment of the rooftop waterproofing structure according to the present invention.

### DETAILED DESCRIPTION OF THE INVENTION

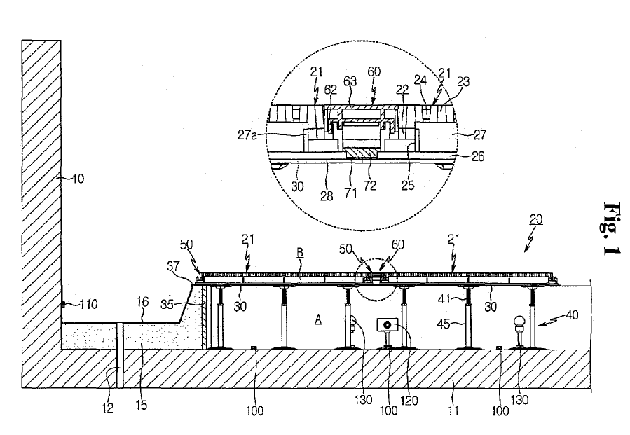

Referring to FIG. 1, a rooftop waterproofing structure according to the present invention is realized via a double floor structure 20 installed on a rooftop 11, and includes upper panels 21 for preventing water from directly falling onto the rooftop 11, support members 40 for supporting the upper panels 21 at a uniform height above the rooftop 11, and drain conduits 50 provided in the upper panel 21 and configured to guide water, falling onto the upper panels 21, to the space outside the upper panels 21 and drain the water.

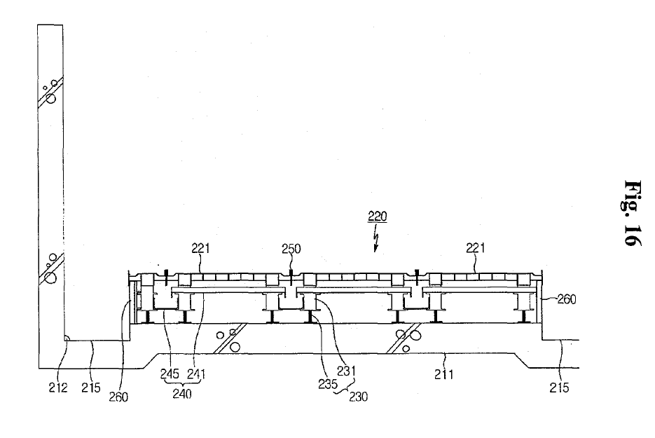

Furthermore, referring to FIG. 15, a rooftop tree planting structure according to the present invention is realized by providing rooftop tree planting 90 in the space above the double floor structure 20. The rooftop tree planting is conducted by laying a porous sheet, formed of a nonwoven fabric 80, on the upper panel 21 and sequentially deploying a soil layer 91 and a vegetation layer 92, in which trees can be easily planted.

Preferred embodiments of the present invention will be described in detail below with reference to the accompanying drawings.

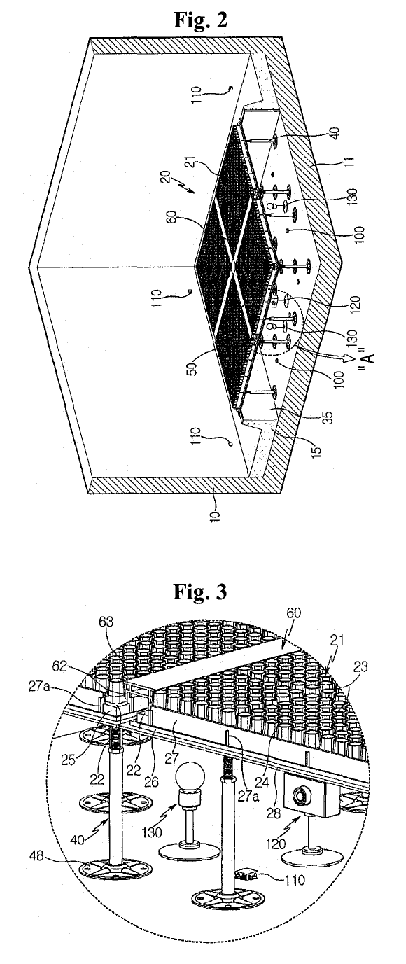

FIG. 1 is a sectional configuration view showing a rooftop waterproofing structure according to the present invention, FIG. 2 is a perspective view of the present invention, and FIG. 3 is an enlarged perspective view showing the principal parts of the present invention.

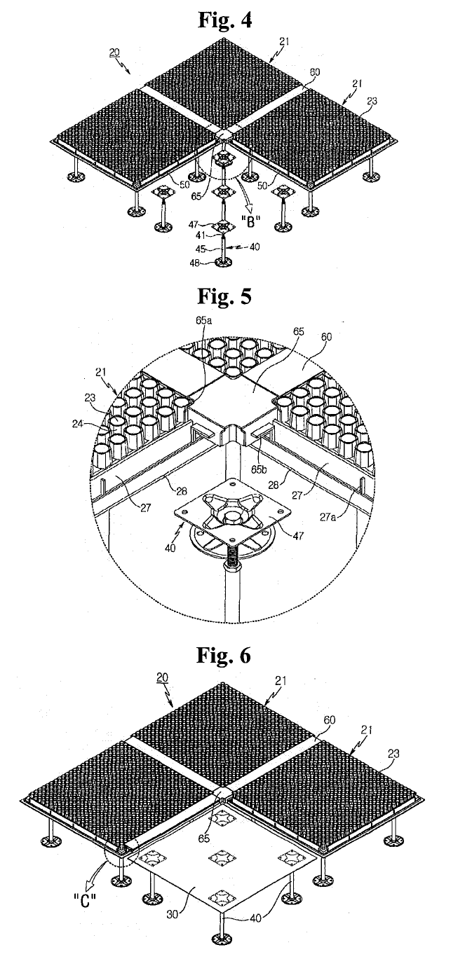

FIGS. 4 to 7 are perspective views of the double floor structure and partially enlarged views of the principal parts thereof, with some parts removed therefrom so as to illustrate the principal construction of the present invention.

The rooftop waterproofing structure according to the present invention is realized via a double floor structure 20 installed on a rooftop 11, and includes upper panels 21 for preventing water from directly falling onto the rooftop 11, support members 40 for supporting the upper panels 21 at a uniform height above the rooftop 11, and drain conduits 50 provided in the upper panels 21 and configured to guide water, falling onto the upper panels 21, to the space outside the upper panels 21 and drain the water.

The double floor structure 20, as shown in FIGS. 1 and 2, is installed above the rooftop 11 in the space inside a rooftop wall 10, and is configured such that the water, drained via the upper panels 21 and the drain conduit 50, is guided to the space outside the double floor structure 20 and is drained via a drain conduit 12 outside the rooftop.

The drain conduits 50 are configured to intersect each other in the X and Y-axis directions on the sides of the peripheral portions of the upper panels, or the portions in which the upper panels 21 abut.

Furthermore, side panels 35 are installed around the double floor structure 20. Through these side panels 35, water is prevented from flowing into the space below the double floor structure 20, and the space below the double floor structure 20 is sealed, thus forming an air insulating layer.

An external insulating material 15 is provided on the rooftop 11 in the space outside the double floor structure 20. An insulating material, such as styrene foam or urethane foam, having a specific thickness, may be used as the external insulating material 15.

Of course, an external waterproofing material 16 may be applied on the external insulating material 15. The external waterproofing material 16 may be formed of a paint-film waterproof layer, or may be constructed by applying a sheet waterproof material, such as a waterproof PVC sheet.

Water sensors 100 for detecting the leakage of water to the rooftop 11 are installed inside the double floor structure 20. Such water sensors 100 may be installed below the upper panels 21, on the support members 40, on the rooftop 11, or elsewhere. It is preferred that the water sensors 100 be installed on respective sections of the rooftop 11, as shown in the drawing.

Alternatively, the water sensors 100 may be installed in the space outside the double floor structure 20 as well as on the rooftop 11. That is, as shown in the drawing, a water sensor 110 may be installed on the rooftop wall 10 at a certain height above the rooftop 11, so that the filling of water in the rooftop 11 due to poor drainage on the rooftop 11 can be detected.

The water sensors 100, installed inside or outside the double floor structure 20, as described above, input signals to a control unit provided in a building administration room or control room, so that measures can be immediately taken in the event of the occurrence of an abnormality.

Furthermore, a surveillance camera 120 may be installed inside the double floor structure 20, along with the water sensors 100. The surveillance camera 120 is installed to acquire image data that is required to check the space inside the double floor structure 20 when the occurrence of an abnormality is detected by a water sensor 100, and or to perform other functions, such as the inspection and management of the space inside the double floor structure 20.

In addition to the use of the surveillance camera, the space inside the double floor structure 20 can be inspected by removing one upper panel 21 and freely moving a remote control vehicle equipped with a fiber optic scope or a small video camera, that is, an investigation robot, under the panel.

Furthermore, illumination devices 130 may be provided in the space inside the double floor structure 20. These illumination devices 130 may act as an illumination means for the surveillance camera 120, but may be more fundamentally used to beautify the upper rooftop space. It is preferred that the upper panels 21 be made of material, such as transparent material or colored material, through which the light, radiated from the illumination devices 130, passes to the outside.

The principal elements of the present invention, constructed as described above, will be described in greater detail below with reference to the accompanying drawings.

First, a plurality of upper panels 21 is assembled together in a matrix arrangement. Although, in the present embodiment, only a structure in which two or four upper panels are assembled together is illustrated, the illustration is given to illustrate the principal elements of the present invention. Of course, it is possible to construct an upper panel assembly by combining a greater number of upper panels 21 in a lattice form, depending on the area of a rooftop.

The upper panels 21 are provided with a plurality of reservoir depressions 23 on the upper surfaces 22 thereof so that a predetermined amount of water is stored in protrusions having a depressed and raised structure. The reservoir depressions 23 are formed to have an approximately cylindrical structure. The structure of the reservoir depressions 63 is not limited thereto, but the shape and height of the reservoir depressions 63 can be variously determined according to the conditions of implementation. Although, in the present embodiment, the reservoir depressions 23 are illustrated as protruding upward, it is possible to form the reservoir depressions 63 to have a structure in which the upper surfaces of the upper panels 21 are inwardly depressed.

The reservoir depressions 23, which are formed on the upper surfaces 22 of the upper panels 21, as described above, are useful, particularly when rooftop tree planting is conducted on the double floor structure 20, as shown in FIG. 15. Since water can be collected in the reservoir depressions 23, water can be continuously supplied to the upper soil.

Drain elements 24 are formed between the reservoir depressions 23 to drain water, overflowing the reservoir depressions 23 and flowing from the outside, to the drain conduits on the sides of the upper panels. Accordingly, the drain elements 24 are formed on relatively low portions in the region having a depressed and raised structure.

Furthermore, the center portion of the upper panels 21 is formed to be higher than the side portion of the upper panels 21 so that water can be effectively drained to the side portion of the upper panels 21.

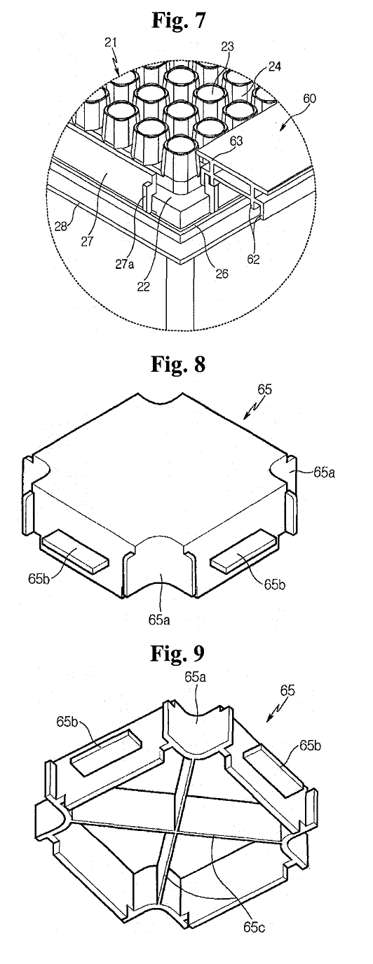

Conduit parts 25 are formed in the sides of the upper panels 21 to form drain conduits 50, and are combined with joint members 60, which are used to assemble the upper panels 21 together. The construction of these elements will be described in detail below with reference to the enlarged view of FIG. 1 and FIG. 7.

Support plates 30 for sealing the space below the upper panels 21 to form a double-air layer insulating structure are provided under the upper panels 21.

The support plates 30 form an air pocket in the space under the upper panels 21, so that two air insulating spaces ‘A’ and ‘B’ are formed between the rooftop 11 and the upper panels 21, as illustrated in FIG. 1, thereby insulating the rooftop.

That is, the upper panels 21 are configured to be open at the bottoms thereof and the support plates 30 are combined with the bottoms of the upper panels 21, so that a space is formed inside the upper panels 21, thereby forming the insulating space B. Furthermore, another insulating space A is formed between the bottoms of the support plates 30 and the rooftop, thereby achieving double air layer rooftop insulation.

Of course, although, in the present embodiment, the double air insulating layer structure has been described, it is possible to have a single structure or a triple structure, according to the implementation conditions.

In particular, it is possible to make the support plates 30 of metal plates so as to provide strength sufficient to support the upper panels 21.

That is, the upper panels 21 are supported by the support members 40 at a certain height above the rooftop. The support plates 30 may be formed of metal plates, for example, steel plates, so as to realize rooftop tree planting above the upper panels 21, or to secure sufficient strength when some other load is applied thereto.

As described above, the support plates 30 formed of metal plates and the support members 40 disposed under the support plates 30 are installed and support the overall structure, therefore the overall structural strength of the double floor structure 20 can be securely and stably maintained.

As a result, the above-described upper panels 21 guide water, resulting from rainfall, to the side of the rooftop and drain it without the intervention of the rooftop, thereby realizing a waterproofing function, and realize a double air insulating layer structure, thereby providing a rooftop insulation function.

Furthermore, water can be continuously provided through the reservoir depressions 23 in the case of rooftop tree planting, and a rootproof function can be achieved due to the inherent features of panel material and secure double jointing, that is, the installation of joint members 60 and sealing members 72. In particular, when problems occur with the waterproofing and insulation performance of the rooftop, the upper panels 21 or the like can be rapidly and accurately repaired, so that maintenance and repair are facilitated, thereby providing an advantage of increasing economical efficiency.

The support members 40 are formed to have a vertically long rod shape, and are installed beneath the support plates 30 in a column structure in the vicinity of the four corners of each upper panel 21. Of course, in the case where the size of the upper panels 21 is larger than a predetermined size, as illustrated in FIG. 4, it is possible to add support members 40 for the centers or some other portion of the upper panels 21.

It is preferred that each of the support members 40 be configured such that an upper rod 41 and a lower rod 45 are combined with each other in a screw fashion, thereby enabling the adjustment of the height of the support members 40. Support pieces 47 and 48, which are supported on the support plates 30 and the rooftop 11, are respectively mounted to the upper and lower ends of the support members 40.

For reference, FIG. 11 shows a structure in which one upper panel 21 is supported by five support members 40. That is, support members 40 are disposed beneath the corners and center of the bottom of the upper panel 21, with the result that each upper panel 21 is supported by a total of five support members 40.

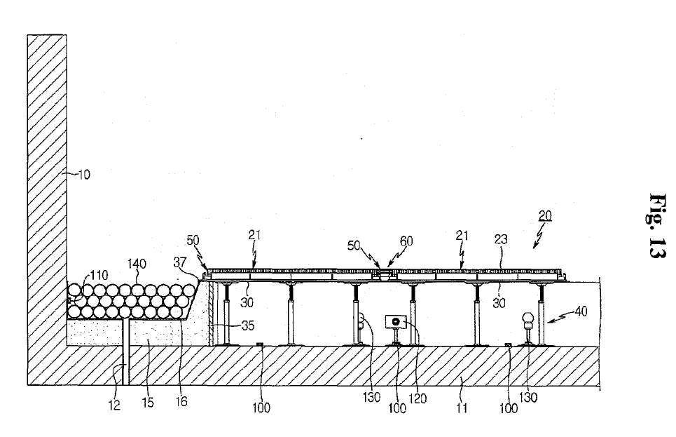

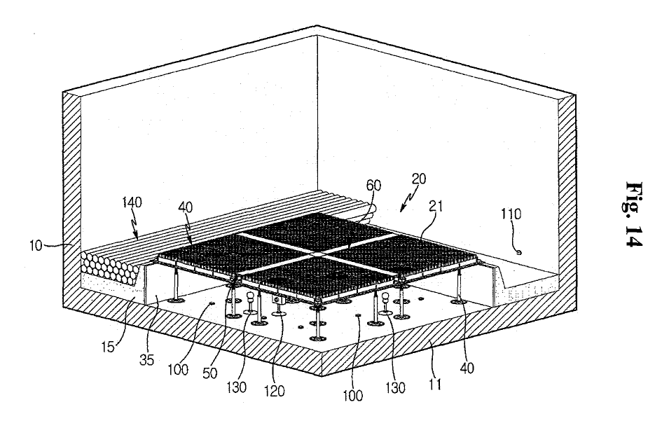

Unlike the above case, FIG. 12 shows a structure in which support members 40 are disposed at respective points at which the corners of the upper panels 21 abut one another and support the upper panels 21. In this case, it is preferred that the support members 40 be fabricated to have sufficient strength to support the upper panels. If necessary, it is possible to add support members 40 for the centers of respective upper panels 21.

Referring to FIGS. 1 and 2, the side panels 35 are configured to extend from the bottoms of the upper panel 21 toward the rooftop 11, and drain guides 37 are provided at the tops of the side panels 35 to allow water, drained through the upper panels 21 and the drain conduits 50, to fall on the side of the rooftop 11 near the wall of the rooftop 11. Here, the drain guides 37 are each formed in an inverted and reversed L shape.

In the above-described double floor structure 20, the joint structure and the drain conduits 50 will be described chiefly with reference to the detailed view of FIG. 1 and FIGS. 4 to 9.

Horizontally extended portions 28, which extend horizontally from the lower edges of the upper panels 21, are formed on the sides of the upper panels 21, so that the support plates 30 are fitted into the insides of the horizontally extended portions. It is preferred that, when the support plates 30 are fitted into the insides of the horizontally extended portions 28, the bottoms of the horizontally extended portions and the bottoms of the support plates are in the same plane, as shown in FIG. 1.

Edge portions 26, which are each formed to have an upwardly bent structure and form flow paths 25 inside them, are formed on the tops of the horizontally extended portions 28.

Vertical walls 27 are erected inside the edge portions 26 with the corners thereof open, and support protrusions 27a, which protrude and support the joint members 60, are formed on the outside surfaces of the vertical walls 27.

Here, the edge portions 26 are formed to be lower than the upper surfaces 22 of the upper panels 21, from which the reservoir depressions 23 protrude, and the vertical walls 27 are formed to be higher than the upper surfaces 22 of the upper panels 21 and lower than the reservoir depressions 23.

Meanwhile, referring to the enlarged view of FIG. 1, neighboring upper panels 21 come into contact with each other at the horizontally extended portions 28 thereof, and waterproof tape 71 and a sealing member 72, such as sealant or urethane, are sequentially applied on the contact portions of the horizontally extended portions 28 to prevent the leakage of water.

The upper panels 21, configured as described above, are assembled together using the joint members 60.

The joint members 60 are each formed in a laterally extending rectangular column shape, as shown in the enlarged view of FIG. 1. Assembly parts 62 are formed at the edges of the lower portions of the joint members 60 so that they are inserted into and mounted on the vertical walls 27. The upper surfaces 63 are each formed to have a structure that extends laterally and covers the tops of the drain conduits 50. Here, it is preferred that the height of the upper surfaces 63 be identical to or similar to that of the reservoir depressions 23, which are formed on the upper panels.

The assembly structure of the joint members 60 can be viewed from the perspective views of FIGS. 2, 4 and 6.

Intersection joints 65 are disposed between the corners of the upper panels 21, that is, at respective intersections of the joint members 60.

The intersection joints 65 are each formed to have an approximately rectangular cap shape, as shown in FIGS. 5, 8 and 9. The corners 65a of the intersection joints 65 are concavely rounded to prevent interference with the reservoir depressions 23 formed on the upper panels 21. Furthermore, assembly protrusions 65b protrude from the four side surfaces of each of the intersection joints 65 toward joint members 60. The locations of the assembly protrusions 65b are determined such that they protrude to the lower spaces of the joint members 60 and are not easily removed therefrom, as shown in the enlarged view of FIG. 1.

Reinforcing ribs 65c, which are arranged in an X arrangement, are formed on each of the intersection joints 65, as shown in FIG. 9. Of course, the construction of the reinforcing ribs may be variously configured to reinforce the strength of the intersection joints 65.

According to the above-described structure, a drain conduit 50 is formed in the portion in which the joint member 60 according to the present invention is disposed. The drain conduit 50 of the present invention is divided into two flow paths.

That is, referring to the enlarged view of FIG. 1, the drain conduit 50 is divided into the region outside the joint member 60 and the region inside the joint member 60. The portion outside the joint member 60 is the portion that allows water, flowing from an upper panel 21, to be drained from the double floor structure 20, and the portion inside the joint member 60 allows water, flowing into the joint member, to be drained via the space above the sealing member 72 to the outside. Of course, inside the double floor structure 20, the sealing member 72 and the waterproof tape 71 are disposed between the upper panels 21, therefore the downward leakage of water can be prevented.

The double waterproof structure and the double flow path structure, around the above-described joint members 60, provide a secondary drain conduit and a waterproof structure even if the waterproofing of the outside drain conduit fails, thereby enabling the realization of a highly reliable waterproof structure.

The water sensors 100, the surveillance camera 120, and the illumination devices 130, which are disposed inside the space under the upper panels, that is, the space inside the double floor structure 20, will be described below.

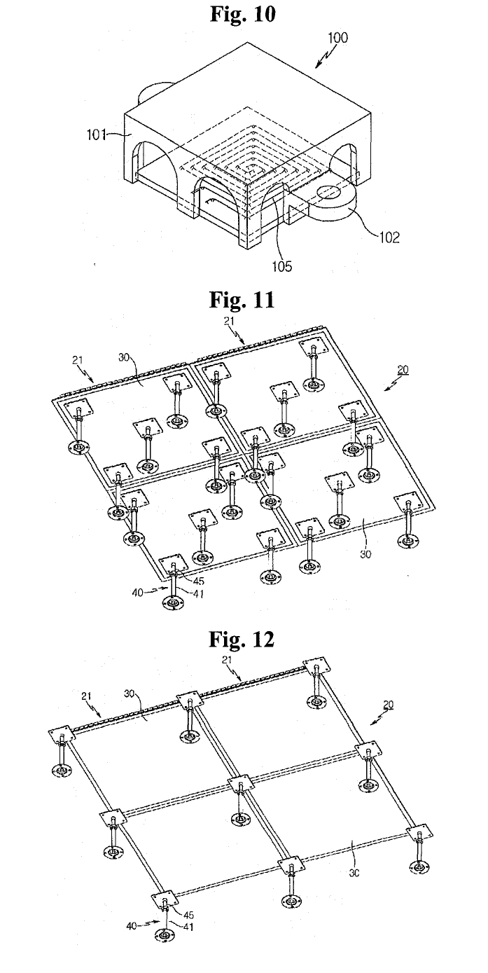

It is preferred that the water sensors 100 be configured to detect water leaking between the upper panels 21 or the support plates 30 and falling onto the rooftop 11, as described below. The construction of the water sensor 100 is as shown in FIG. 10.

That is, the water sensor 100, shown in FIG. 10, is configured such that the sides of a sensor housing 101 are open, so that an internal detection circuit 105 detects water and generates a signal in the case where the water, falling onto the rooftop, flows into the housing 101. It is preferred that mounting tabs 102 protrude from both sides of the sensor housing 101 so that the water sensor 100 can be conveniently fastened using screws. The water sensor 100 is an example, and it is not necessary for the water sensor to have a structure identical to that shown in FIG. 10. When necessary, various water sensors 100 capable of detecting water on the rooftop can be used.

When the water sensor 100 is installed inside the double floor structure 20, the leakage of water is detected, and then inspection and repair can be rapidly performed in the case where the leakage of water occurs through the upper structure. In the double floor structure 20, the inner space thereof is closed by the upper panels 21 and the side panels 35, so that, in the case where an upper panel 21 is damaged or the leakage of water occurs through the side panels 35, the leakage of water can be detected only after a considerable amount of time has elapsed. However, in the case where a plurality of water sensors 100 is installed in the space inside the double floor structure 20, the leakage of water can be rapidly detected and appropriate measures can be taken.

Furthermore, it is preferred that the surveillance camera 120 be installed along with the water sensor 100. The surveillance camera is configured to inspect the space inside the double floor structure 20 in the case where the leakage of water is detected by the water sensor 100, periodically or when necessary.

Accordingly, the surveillance camera 120 is not necessarily installed along with the water sensor 100, but the surveillance camera 120 alone may be installed, without the installation of the water sensor 100 depending on need.

However, since the space inside the double floor structure 20 is dark, it is preferred that the surveillance camera 120 be equipped with illumination equipment or be used along with the illumination devices 130, which will be described below.

The illumination devices 130 may be used for two purposes. One of them is to illuminate the inner space when the surveillance camera 120 is used, and the other is to beautify the appearance of the double floor structure 20 with illumination light.

In the above case, it is preferred that the upper panels 21, the joint members 60 and the intersection joints 65 be fabricated of colorless or colored transparent material. Furthermore, it is preferred that the support plates 30 be fabricated of material identical to or similar to that of the upper panels 21, other than metal plates, so that light can pass through the support plates 30. Of course, it is possible to eliminate the support plates 30 and directly connect the support members 40 to the upper panels 21.

Meanwhile, it is preferable to additionally install a water sensor 110 in the space outside the double floor structure 20, as described above. As shown in FIGS. 1 and 2, the water sensor 110 is installed on the rooftop wall 10, so that it can detect water and provide notification in the case where the drain conduit 12 is blocked and then the water fills the rooftop to a height equal to or higher than a specific height.

A water sensor of the type identical to that of the water sensors 100 that are installed inside the double floor structure 20 may be used as the water sensor 110 having the above-described function.

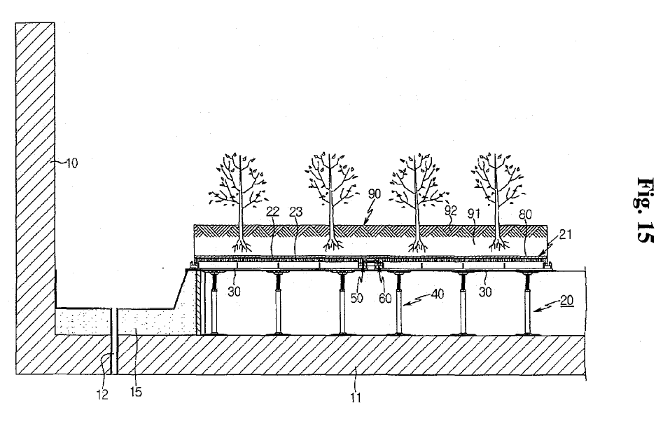

FIGS. 13 and 14 show another construction of the present invention, wherein FIG. 13 is a sectional view showing the overall construction, and FIG. 14 is a cutaway perspective view showing the overall construction.

Since the fundamental construction of a rooftop waterproofing structure according to another embodiment of the present invention, shown in the drawing, is the same as the construction of the embodiment shown in FIGS. 1 to 10, the same reference numerals are assigned to the same elements, and thus a description thereof is omitted here.

However, in another embodiment of the present invention, an external insulating material 15 having a certain height is installed outside the double floor structure 20, that is, in the space between the side panels 35 and the wall 10, and lightweight filling members 140 formed of a bundle of plastic pipes are installed on the external insulating material 15.

The lightweight filling members 140 are installed to fill the space outside the double floor structure 20 to an appropriate height and realize a function of insulating the rooftop in cooperation with the external insulating material 15, which is installed under the lightweight filling members 15.

Although the structure in which the lightweight filling members 140 are formed of plastic pipes is illustrated, it is possible to dispose respective plastic pipes in other arrangements, or to employ general lightweight aggregates, according to necessity. That is, it is possible to select and install various filling members according to rooftop design conditions as long as they fill the space outside the double floor structure 20, have insulation capability, and provide drainage.

However, it is preferred that the lightweight filling members 140 be formed of relatively lightweight material, with the load applied to the rooftop taken into account.

Since the remainder of the construction is the same as that of the above-described embodiment, a detailed description thereof is omitted here.

Meanwhile, rooftop tree planting can be implemented on the above-described rooftop having a double floor type-guidance waterproof structure according to the present invention. FIG. 15 is a sectional view illustrating a rooftop tree planting structure.

As shown in the drawing, the rooftop tree planting 90 is realized above the double floor structure 20. The rooftop tree planting is conducted by laying a porous sheet, formed of a nonwoven fabric 80, on the upper panel 21 and sequentially deploying a soil layer 91 and a vegetation layer 92, in which trees can be easily planted.

In this case, since reservoir depressions 23 are formed in the upper surfaces 22 of the upper panels 21, water can be continuously supplied, and a rootproof function can be achieved due to the inherent features of panel material and secure double jointing, that is, the installation of joint members 60 and sealing members 72. Furthermore, drain conduits 50 are provided around the upper panels 21 in the X and Y-axis directions, so that an effective drain structure is obtained and a desired tree planting environment can be produced.

Meanwhile, FIG. 16 is a diagram showing the construction of another embodiment of the rooftop waterproofing structure according to the present invention, which will be briefly described below.

As shown in the drawing, the rooftop waterproofing structure includes a plurality of upper panels 221 located at a height above a rooftop 211, support members 230, each formed of an upper rod 231 and a lower rod 235 and configured to control height so that the upper panels 221 are supported above the rooftop 211, and drain conduits 240 located between the upper panels 221 and the rooftop 211 and configured to drain water, falling from the upper panels 221, to a slab edge 215.

Although, in this case, the upper panels 221 and the support members 230 may be constructed in the same way as those of the embodiment of the present invention, the structure of the installation of the drain conduits 240 is different in the present embodiment.

That is, the drain conduits 240 are configured such that they are arranged to intersect each other under the portions in which the upper panels 221 abut in the X and Y-axis directions and to guide and drain drained water to a drain hole 212.

That is, under the condition that the upper panels 221 are disposed in a matrix arrangement, a long-distance drain conduit 245 is provided in one of the X and Y-axis directions, and a short-distance drain conduit 241, which will be connected to the long-distance drain conduit 241, is provided in the other direction.

In the drawing, the reference numeral 220 designates a double floor structure, the reference numeral 250 designates joint members that connect the upper panels to each other, and the reference numeral 260 designates side panels that block the sides of the double floor structure.

### INDUSTRIAL APPLICABILITY

The present invention is configured such that the double floor structure is installed on the rooftop and water is naturally guided and drained to the drain hole, rather than using a method of preventing water from penetrating the rooftop, so that the process of installation of waterproofing equipment can be simplified and the cost of construction can be considerably reduced. In particular, the occurrence of defects in a waterproof layer can be fundamentally prevented, so that more efficient and economical rooftop waterproofing can be realized. Furthermore, when the leakage of water occurs, the detection of the location of a defect and the repair of the defect can be rapidly and easily performed.

According to the above-described present invention, three principal functions that are realized on the uppermost part of a building, that is, ‘waterproofing’, ‘insulation’ and ‘tree planting,’ are integrated into a single triune system, so that more rapid, simple and economical construction is enabled.

Furthermore, since the present invention is configured to drain water through the space between the upper panels, rather than the space under the upper panels, the process of the installation of the double floor structure can be simplified and the performance of rooftop waterproofing as well as building insulation can be further improved.

That is, the present invention has advantages in that water resulting from rainfall or the like is guided to the peripheral region of a rooftop without the intervention of the rooftop and is then drained, thereby realizing a waterproofing function, and the double air insulating layer is realized, thereby increasing the performance of rooftop insulation. Furthermore, water can be continuously supplied to the reservoir depressions formed in the upper panels when rooftop tree planting is conducted, and a rootproof function can be achieved due to the inherent features of panel material and secure double jointing. When a problem occurs in the performance of rooftop waterproofing and insulation, the problem can be solved by repairing only the upper panels or the like, and maintenance and repair are facilitated, thereby increasing economical efficiency.

Moreover, according to the present invention, the water sensors are installed inside the double floor structure, so that the leakage of water through the upper panels can be accurately checked, thereby realizing more complete and reliable performance of waterproofing and enabling repair construction to be performed at an appropriate time.

Furthermore, according to the present invention, the surveillance cameras and the illumination devices are installed inside the double floor structure, so that maintenance and repair is facilitated and the appearance of a waterproofed structure can be further beautified.

Moreover, according to the present invention, the depressed and raised portions and the reservoir depressions are formed on the panels, and thus rooftop tree planting is enabled without requiring a separate drain plate or layer. In the case where a rooftop tree planting facility is installed on the rooftop double floor-type guidance waterproof structure, better waterproofing performance can be maintained, a completely rootproof and draining structure can be provided, and a more desired tree planting environment can be constructed.

What is claimed is:

1. A rooftop double floor-type guidance waterproof structure, comprising:
upper panels for preventing water from directly falling onto a rooftop;
support members for supporting the upper panels at a uniform height above the rooftop; and
drain conduits provided on tops or sides of the upper panels and configured to guide water, falling onto the upper panels, to a space outside the upper panels, and to drain the water.

2. The rooftop double floor-type guidance waterproof structure as set forth in claim 1, wherein:
the upper panels comprise a plurality of upper panels; and
the drain conduits are provided in the sides of the upper panels or between the upper panels, assembled together.

3. The rooftop double floor-type guidance waterproof structure as set forth in claim 1, wherein:
the upper panels comprise a plurality of upper panels, the plurality of upper panels being assembled together by joint members.

4. The rooftop double floor-type guidance waterproof structure as set forth in claim 1, wherein the drain conduits are formed between the sides of the upper panels and the joint members.

5. The rooftop double floor-type guidance waterproof structure as set forth in claim 1, wherein the upper panels are combined with insulating plates in lower portions thereof, so that an air pocket can be formed inside the upper panels.

6. The rooftop double floor-type guidance waterproof structure as set forth in claim 1, wherein the upper panels are provided with drain elements that are located on the upper panels and that are composed of depressed and raised portions to effectively drain water to the drain conduits.

7. The rooftop double floor-type guidance waterproof structure as set forth in claim 1, wherein the upper panels are provided with a plurality of reservoir depressions on upper surfaces thereof to collect a predetermined amount of water therein.

8. The rooftop double floor-type guidance waterproof structure as set forth in claim 1, further comprising one or more water sensors that are located under the upper panels and detect leakage of water to the rooftop.

9. A rooftop tree planting structure, comprising:
upper panels for preventing water from directly falling onto a rooftop;
support members for supporting the upper panels at a uniform height above the rooftop; and
drain conduits provided in the upper panels and configured to guide water, falling onto the upper panels, to a space outside the upper panels and drain the water;
wherein rooftop tree planting is conducted in a space above the upper panels.

10. The rooftop tree planting structure as set forth in claim 9, wherein a porous sheet capable of passing water therethrough is laid on upper surfaces of the upper panels, and rooftop tree planting is conducted on the porous sheet.
